(19) United States
(12) Patent Application Publication
(10) Pub. No.: US 2005/0252019 A1
(43) Pub. Date: Nov. 17, 2005

(54) Quilting template

(76) Inventors: Christine Gordon, Fort Bragg, CA (US); Ernest Handelin, Fort Bragg, CA (US)

Correspondence Address: Christine Gordon, POB 1531, Fort Bragg, CA, 95437, US

(21) Appl. No.: 10/843,996

(22) Filed: May 13, 2004

(51) Int. Cl. B43L 7/00

(52) U.S. Cl. 33/566

(57) ABSTRACT

Quilting Template with a flat, transparent, circular plastic disk approximately one eighth of an inch thick, a centermost conical aperture to allow a pencil point or pin to act as a pivot shaft, a plurality of concentrically and radially disposed cutouts spaced around the center aperture, a plurality of conically shaped apertures placed at strategic locations within the disk, and silk screened or otherwise printed indicators on the disk. A preferred embodiment includes the radial cutouts are approximately one quarter of one inch wide so that the outer arc of the cutout can be used as a retaining wall for guiding a standard hand operated cutting wheel and the inner arc can be used to draw a sew line that is an ideal distance from the edge of the fabric being cut.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sewing aids and more specifically to a quilting template.

Quilting is an age old practice of cutting portions of fabric and sewing them together to make a larger, blanket sized design.

The individual cut fabric pieces need to be laid out with pencil or the like and then cut out. Frequently, a quilter will cut out a pattern so that he or she may use it as a cutting guide. Recently, the use of a hand held rotary cutter makes the process of cutting cleanly through one or more pieces of fabric easier and quicker.

However, there is a deficiency in the prior art in that most patterns are destroyed in the process of using the rotary cutter in close proximity to them. There are plastic templates available in the market place however they are relatively thin and can be easily damaged by a rotary cutter. Additionally, existing templates do not allow the user to lay out a sew line as well as a cut line at each radial template portion.

### BRIEF SUMMARY OF THE INVENTION

The primary object of the invention is to provide a quilting template that helps a quilter cut radial patterns out of fabric.

Another object of the invention is to provide a quilting template that can help cut full circles or portions of circles of a plurality of diameters.

Another object of the invention is to provide a quilting template that allows the user to employ the use of a standard rotary cutting wheel.

A further object of the invention is to provide a quilting template that can help a user mark a radial sewing line a fixed distance from a radial cut line.

Yet another object of the invention is to provide a quilting template that helps a user mark various angles on the fabric to be cut.

Still yet another object of the invention is to provide a quilting template that allows the user to completely see the fabric being cut.

Another object of the invention is to provide a quilting template that will not be cut or otherwise damaged by a standard cutting wheel.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Quilting Template comprising: a flat, transparent, circular plastic disk approximately one eight of an inch thick, a centermost conical aperture to allow a pencil point or pin to act as a pivot shaft, a plurality of concentrically and radially disposed cutouts spaced around said center aperture, a plurality of conically shaped apertures placed at strategic locations within said disk, and silk screened or otherwise printed indicators on said disk.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention.

FIG. 2 is a partial plan view of the present invention.

FIG. 3 is a section view of the conical aperture of the present invention.

FIG. 4 is a section view of the radial cut out template portion of the present invention.

FIG. 5 is a perspective view of a person using the present invention.

FIG. 6 is a perspective view of various cut out fabric pieces that have been produced with the help of the present invention.

FIG. 7 is a perspective view of a person cutting out fabric using a rotary cutter and a straight edge after guide lines have been drawn with the help of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

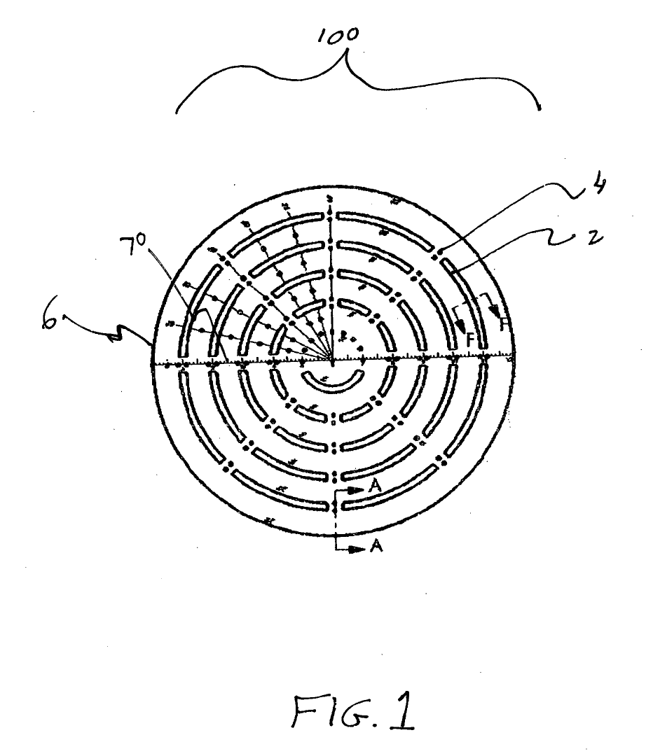

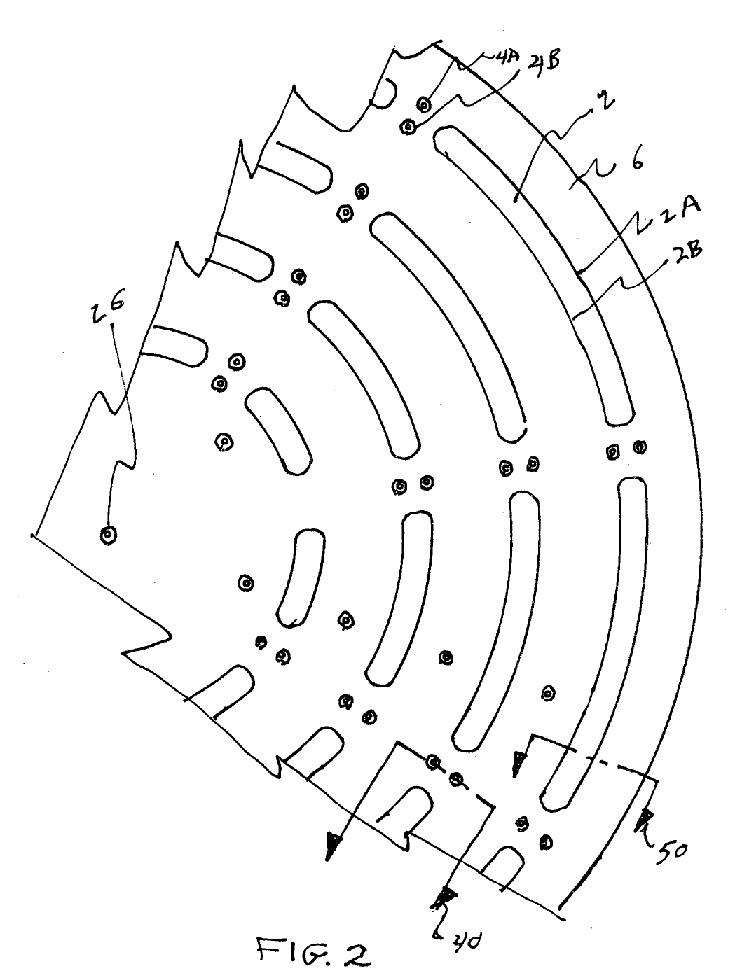

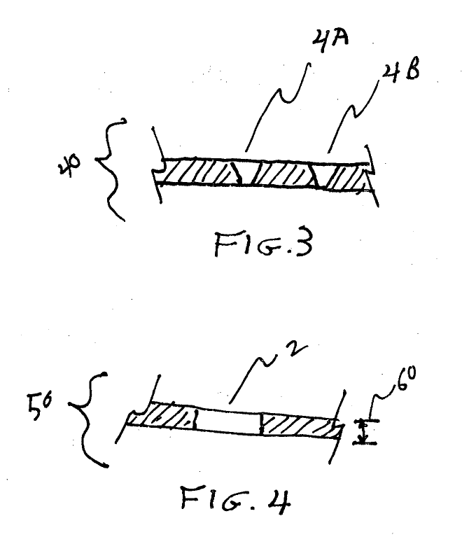

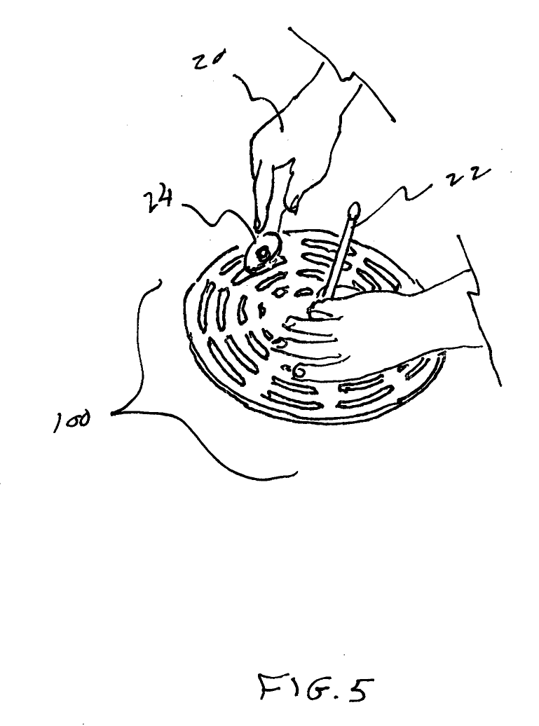

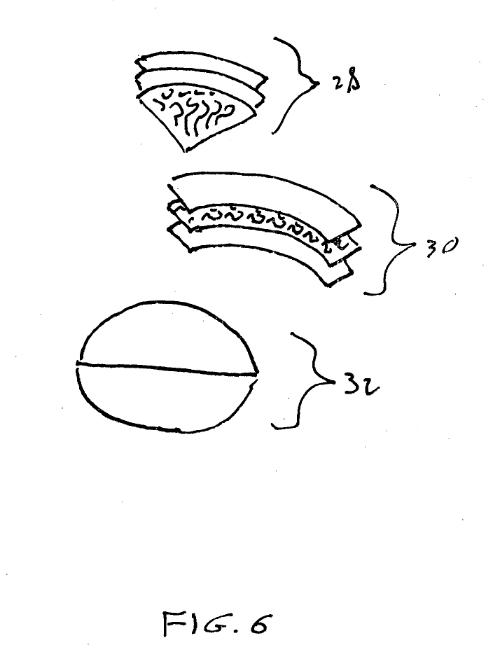

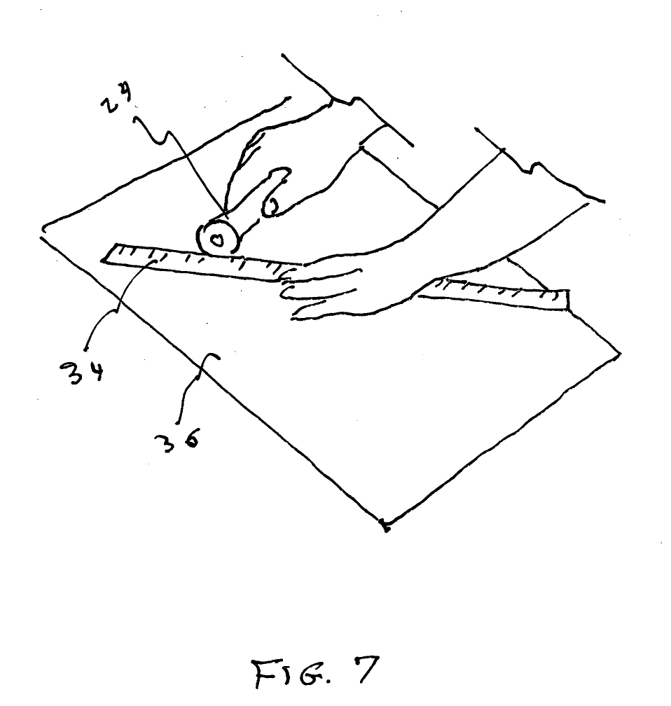

Referring now to FIG. 1 we see a plan view of the quilting template of the present invention 100. The quilting template 100 is approximately twelve inches in diameter 6 and is comprised of a flat plastic disk that includes a plurality of radial cutouts 2 and conical apertures 4. The disk is made of transparent plastic such as acrylic or SAN and is approximately one eight of an inch thick. Additionaly various indicies and markiings such as ruler markings can be printed 70 onto the disk to further help the user design his or her quilt pattern. FIG. 2 shows a partial enlarged view of the present invention. The radial cutouts 2 are approximately one quarter of an inches wide as shown by the distance between 2A and 2B. This distance allows the user to cut out a radial pattern by rolling a rotary cutter along radial edge 2A and then marking radial edge 2B with a pencil or the like to show the user where to sew after the cut is made. Apertures 4A 4B let the user mark dots for future reference so that a straight edge 34 can be placed on fabric 36 along the line formed by the dots and a straight cut made as shown in FIG. 7 Figure three shows section line 40 through conical apertures 4A, 4B. The apertures are one eighth of an inch in diameter at the top surface and one sixteenth of an inch in diameter at its bottom surface. This allows for easy insertion of a pencil point. FIG. 4 shows a section view 50 of a radial cutout 2. The walls of the radial cutout portion are relatively perpendicular to the surface of the disk 6. The thickness 60 of the disk is also shown. This thickness is sufficient to prevent the template 100 from being damaged by the cutting blade of cutter 24 FIG. 5 shows a person 20 using a standard rotary cutter 24 with the present invention 100. The user is cutting along the outside diameter of the radial cutout and using a pencil whose point is inserted into central aperture 26. The user can cut the section of a circle associated with the particular radial template portion and can then rotate the template slightly to continue to cut out a circle or portion of a circle. FIG. 6 shows perspective views of various pieces of cut out fabric that have been created by using the present invention 100. Notice that pie shapes 28, rainbow shapes 30 or semi circular shapes 32 have been cut out. Obviously, full circles and other portions of circles can be cut out using this template.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. Quilting Template comprising:
a flat, transparent, circular plastic disk approximately one eighth of an inch thick;
a centermost conical aperture to allow a pencil point or pin to act as a pivot shaft;
a plurality of concentrically and radially disposed cutouts spaced around said center aperture;
a plurality of conically shaped apertures placed at strategic locations within said disk; and
silk screened or otherwise printed indicators on said disk.

2. Quilting Template as claimed in claim 1 wherein said radial cutouts are approximately one quarter of one inch wide so that the outer arc of the cutout can be used as a retaining wall for guiding a standard hand operated cutting wheel and the inner arc can be used to draw a sew line that is an ideal distance from the edge of the fabric being cut.

3. Quilting Template as claimed in claim 1 wherein said disk may be transparent or translucent.

4. Quilting Template as claimed in claim 1 wherein, in the preferred embodiment, said disk is twelve inches in overall diameter, with said radiall cutouts being concentrically placed approximatly every inch center to center away from said center point.

5. Quilting Template as claimed in claim 1 wherein said conical apertures having a top most diameter of one eighth of and inch and a lower diameter of one sixteenth of an inch.

6. Quilting Template as claimed in claim 1 wherein said conical apertures allow the user to place marks in a linear and, or radially angular fashion to allow the user to place a straight edge along said lines to accurately cut fabric.
